(19) United States
(12) Patent Application Publication
(10) Pub. No.: US 2007/0047786 A1
(43) Pub. Date: Mar. 1, 2007

(54) System and method for creating robust training data from MRI images

(75) Inventors: Ameha Aklilu, Chapel Hill, NC (US); Raed A. Hijer, Raleigh, NC (US)

Correspondence Address: VANLEEUWEN & VANLEEUWEN, P.O. BOX 90609, AUSTIN, TX, 78709-0609, US

(73) Assignee: Lenovo (Singapore) Pte. Ltd.

(21) Appl. No.: 11/211,972

(22) Filed: Aug. 25, 2005

(51) Int. Cl. G06K 9/00

(52) U.S. Cl. 382/128

(57) ABSTRACT

A method, computer program product, and data processing system for building a training set and classifier model for tissue classification from MRI images using limited training data are disclosed. In a preferred embodiment, the method begins with a given set of multispectral MRI scans of an abdominal slice of a human organ. A clustering algorithm is applied to the image data to cluster different objects in the image into unique clusters. A deterministic initialization procedure is applied to the clustering algorithm to ensure solution uniqueness, convergence, and the creation of meaningful clusters. A human domain expert then produces a corrected set of clusters by retaining only clusters of interest. A training set is generated that represents samples of each of the tissue types of interest, as well as a validation set. One or more classifiers are constructed from the training set and then evaluated for accuracy using the validation set.

### BACKGROUND OF THE INVENTION

1. Technical Field

The present invention relates generally to the area of computerized tools for aiding medical professionals in the diagnosis of disease. Specifically, the present invention provides a method, computer program product, and data processing system for building a training set for training a classifier (a machine-learning algorithm) to recognize malignancies from magnetic resonance images.

2. Description of the Related Art

Magnetic resonance imaging (MRI) (also referred to as nuclear magnetic resonance (NMR) imaging) requires placing an object to be imaged in a static magnetic field, exciting nuclear spins in the object within the magnetic field, and then detecting signals emitted by the excited spins as they precess within the magnetic field. Through the use of magnetic gradient and phase encoding of the excited magnetization, detected signals can be spatially localized in three dimensions.

One particularly active area of research is in the use of computers to analyze MRI data. Although computerized image processing and control has been an integral part of magnetic resonance imaging from the very beginning and advancements in MRI image processing continue to be made, recent research has also focused on the use of computer technology as a diagnostic tool in the interpretation of MRI results. In particular, researchers have looked to using classifier software to allow a computer to distinguish among different types of tissues displayed in an MRI scan. These classifiers utilize machine learning techniques to develop a model for distinguishing among the various types of tissues. Training data consisting of MRI data that has been annotated by a domain expert (such as a radiologist) is fed into the classifier, and the classifier analyzes the training data to identify patterns in the data that indicate when a given sample corresponds to one known type of tissue or another. After the classifier has been trained, a set of similarly annotated validation data is typically used to test the accuracy of the classifier. This type of machine learning is known as “supervised learning,” since the training and validation data is annotated by a human “supervisor” or “teacher.” One example of a supervised learning system for tissue classification is described in TAXT, T. et al. Multispectral Analysis of the Brain Using Magnetic Resonance Imaging. IEEE Transactions on Medical Imaging, Vol. 13, No. 3, pp. 470-481, ISSN 0278-0062.

Large amounts of accurate training data are needed to produce a robust classifier model. In many instances, training data may not be abundant. Moreover, the creation of a training data set is usually a labor-intensive process and somewhat prone to error. In particular, in the case of image classification, where the purpose is to distinguish healthy tissues from potentially cancerous ones, for instance, existing methods may produce inconsistent results due to variations in the quality of the training images.

What is needed, therefore, is a method of producing a more accurate classifier model from limited training data. The present invention provides a solution to this and other problems, and offers other advantages over previous solutions.

### SUMMARY OF THE INVENTION

The present invention provides a method, computer program product, and data processing system for building a training set and classifier model for tissue classification from MRI images using limited training data. According to a preferred embodiment, the method begins with a given set of multispectral MRI scans of an abdominal slice of a human organ. A clustering algorithm is applied to the image data to cluster different objects in the image into unique clusters. A deterministic initialization procedure is applied to the clustering algorithm to ensure solution uniqueness, convergence, and the creation of meaningful clusters. A human domain expert then produces a corrected set of clusters by retaining only clusters of interest (e.g., benign and malignant liver tissue in a classifier designed to diagnose liver cancer). A training set is then generated that represents samples of each of the tissue types of interest, as well as a validation set. One or more classifiers are then constructed from the training set and then evaluated for accuracy using the validation set.

The foregoing is a summary and thus contains, by necessity, simplifications, generalizations, and omissions of detail; consequently, those skilled in the art will appreciate that the summary is illustrative only and is not intended to be in any way limiting. Other aspects, inventive features, and advantages of the present invention, as defined solely by the claims, will become apparent in the non-limiting detailed description set forth below.

### BRIEF DESCRIPTION OF THE DRAWINGS

The present invention may be better understood, and its numerous objects, features, and advantages made apparent to those skilled in the art by referencing the accompanying drawings, wherein:

FIG. 1 is a diagram of a example magnetic resonance imaging apparatus that may be utilized to obtain image data to be processed by a preferred embodiment of the present invention;

FIGS. 2A-2C are diagrams of gradient fields used to select a particular slice of a subject being scanned using a magnetic resonance imaging apparatus such as that depicted in FIG. 1;

FIG. 3 is a block diagram of an example magnetic resonance imaging apparatus that may be utilized to obtain image data to be processed by a preferred embodiment of the present invention;

FIG. 4 is a flowchart representation of a process of producing training and validation data sets and training and validating a tissue classifier using those data sets in accordance with a preferred embodiment of the present invention;

FIG. 5 is a flowchart representation of a process of performing clustering of image data in accordance with a preferred embodiment of the present invention;

FIG. 6 is a diagram illustrating the creation of a set of initial cluster means in accordance with a preferred embodiment of the present invention;

FIG. 7A is a diagram of an MRI image of an abdominal cross-section of a patient;

FIG. 7B is a diagram illustrating the organization of the MRI image data in FIG. 7A into a plurality of discrete clusters and the selection of a subset of those clusters to be used as training or validation data in accordance with a preferred embodiment of the present invention; and

FIG. 8 is a block diagram of a data processing system in which a preferred embodiment of the present invention may be implemented.

### DETAILED DESCRIPTION

The following is intended to provide a detailed description of an example of the invention and should not be taken to be limiting of the invention itself. Rather, any number of variations may fall within the scope of the invention, which is defined in the claims following the description.

Magnetic Resonance Imaging

The following is a brief description of magnetic resonance imaging for the purpose of understanding the classification problem that a preferred embodiment of the present invention solves and source data that said preferred embodiment analyzes for the purpose of advising the user of a potential diagnosis. Although a preferred embodiment of the present invention itself performs software post-processing on MRI data (hence, one need not actually construct magnetic resonance imaging equipment to practice the invention), it is helpful to understand the nature of the data that a preferred embodiment of the present invention processes, so a brief introduction to general MRI concepts is provided here. A more complete description of MRI may be found in U.S. Pat. No. 4,254,778 (CLOW et al.) 1981-3-10.

For the examination of a sample of biological tissue, nuclear magnetic resonance (NMR) primarily relates to protons (i.e., hydrogen nuclei) in the tissue. In principle however, other nuclei could be analyzed, for example, those of deuterium, tritium, fluorine or phosphorus. Protons each have a nuclear magnetic moment and angular momentum (spin) about the magnetic axis. If a steady magnetic field Bₒ is applied to a sample, the protons align themselves with the magnetic field, many being parallel thereto and some being anti-parallel so that the resultant spin vector is parallel to the field axis. Application of an additional field B₁ which is an RF (radio frequency) field of frequency related to B₀, in a plane normal to B₀, causes resonance at that frequency so that energy is absorbed in the sample. The resultant spin vectors of protons in the sample then rotate from the magnetic field axis (z-axis) towards a plane orthogonal thereto (x,y). The RF field is generally applied as a pulse and if ∫B₁dt for that pulse is sufficient to rotate the resultant spin vectors through 90° into the x,y plane the pulse is termed a 90° pulse.

On removal of the B₁ field the equilibrium alignments re-establish themselves with a time constant T₁, the spin-lattice relaxation time. In addition a proportion of the absorbed energy is re-emitted as a signal which can be detected by suitable coils, at a resonant frequency. This resonance signal decays with a time constant T₂ and the emitted energy is a measure of the proton content of the sample. The decay of this signal is typically referred to in the art as “free induction decay” (FID).

As so far described, the resonance signal detected relates to the entire sample. If individual resonance signals can be determined for elemental samples in a slice or volume of a patient then a distribution of proton densities can be determined for that slice or volume. Additionally or alternatively it is possible to determine a distribution of T₁ or T₂.

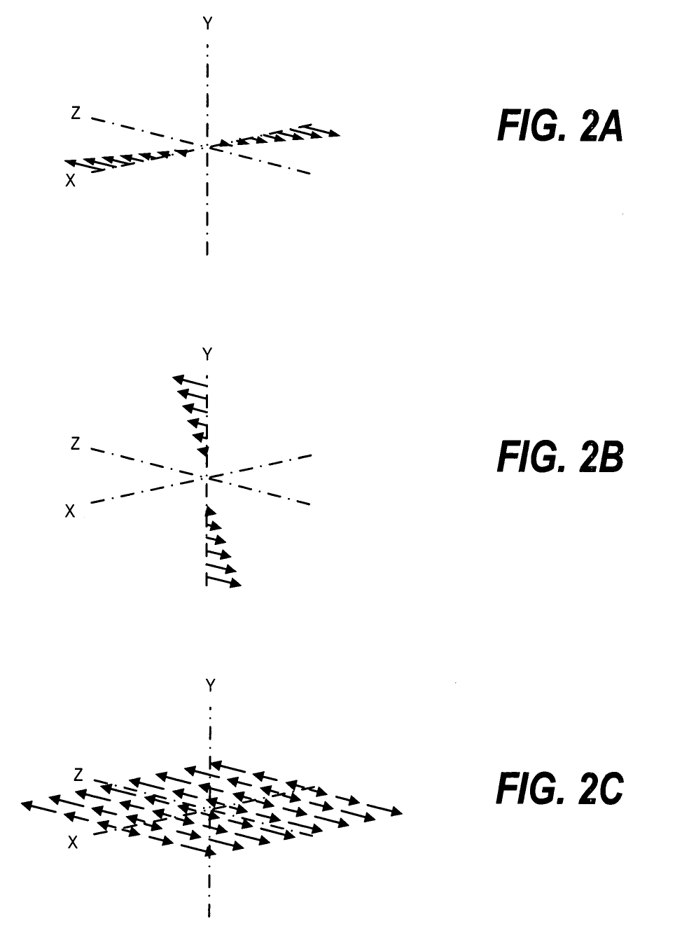

In a typical medical imaging application, the examination is particularly of a cross-sectional slice of the patient (tomography), although examination of a larger volume is possible, either by examination of a plurality of adjacent slices, or by a specifically volume scan. According to the usual practice in the art, the first step in performing MRI-based tomography is to ensure that resonance occurs at the chosen frequency only in the selected slice. Since the resonance frequency (the Larmor frequency) is related to the value of B₀, the slice selection is achieved by imposing a gradient on B₀ so that the steady field is of different magnitude in different slices of the patient. The steady and uniform B₀ field is applied as before, usually longitudinal to the patient. An additional magnetic field G_{z} is also applied (depicted in FIG. 2C), being a gradient

$${G}_{z} = \frac{\partial {B}_{z}}{\partial z} .$$

If then the pulsed B₁ field is applied at the appropriate frequency, resonance only occurs in that slice in which the resonance frequency as set by B₀ and the local value of G_{z} is equal to the frequency of B₁. If the B₁ pulse is a 90° pulse, it brings the spin vectors into the x, y plane only for the resonant slice. Since the value of the field is only significant during the B₁ pulse, it is only necessary that G_{z} be applied when B₁ is applied, and in practice G_{z} is also pulsed. The B₁ and G_{z} fields are therefore then removed. It is still, however, possible to change the resonant frequencies of the spin vectors which are now in the x, y, plane. This is achieved by applying a further field

$${G}_{R} ( actually \frac{\partial {B}_{z}}{\partial R} ,$$

where R represents the radial direction in cylindrical coordinates), which is parallel to B₀. The intensity of G_{R}, however, varies from a maximum at one extreme of the slice, through zero in the center to a maximum in the reverse direction on the opposite surface. Correspondingly the resonant frequencies will vary smoothly over the plane of the slice from one side to the other.

As mentioned before, the signal which now occurs is at the resonant frequency. Consequently the signals received from the slice will also have frequencies which vary across the slice in the same manner. The amplitude at each frequency then represents, inter alia, the proton density in a corresponding strip parallel to the zero plane of G_{R}. The amplitude for each strip can be obtained by varying the detection frequency through the range which occurs across the slice. Preferably however the total signal at all frequencies is measured. This is then Fourier analyzed by well-known techniques to give a frequency spectrum. The frequency appropriate to each strip will be known from the field values used and the amplitude for each frequency is given by the spectrum.

As discussed, for the radial gradient field G_{R}, the individual signals derived from the frequency spectrum, for increments of frequency, correspond to incremental strips parallel to the zero plane of G_{R}. These signals are similar in nature to the edge values derived and analyzed for x-ray beams in computerized tomography.

It will be apparent that by changing the orientation, relative to the x-y plane, of the zero plane of G_{R}, further sets of signals can be obtained representing proton densities along lines of further sets of parallel lines at corresponding further directions in the examined slice. The procedure is therefore repeated until sufficient sets of “edge values” have been derived to process by methods like those used for sets of x-ray beams. In practice the G_{R} field is provided by combination of two fields Gₓ and G_{y} (FIGS. 2A and 2B, respectively) which are both parallel to B_{z} but have gradients in orthogonal directions. The direction of the gradient of the resultant G_{R} is therefore set by the relative magnitudes of Gₓ and G_{y}.

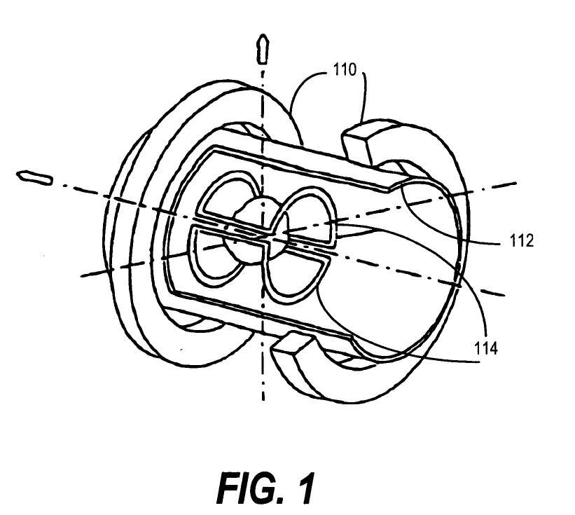

FIG. 1 is a perspective view partially in section illustrating a conventional coil apparatus in an NMR imaging system. Briefly, a uniform static field B₀ is generated by the magnet comprising coil pair 110. The gradient fields, depicted in FIGS. 2A-2C are generated by a complex gradient coil set which can be wound on cylinder 112. A radio-frequency (RF) field B₁ is generated by saddle coils 114. A patient undergoing imaging would be positioned within saddle coils 114.

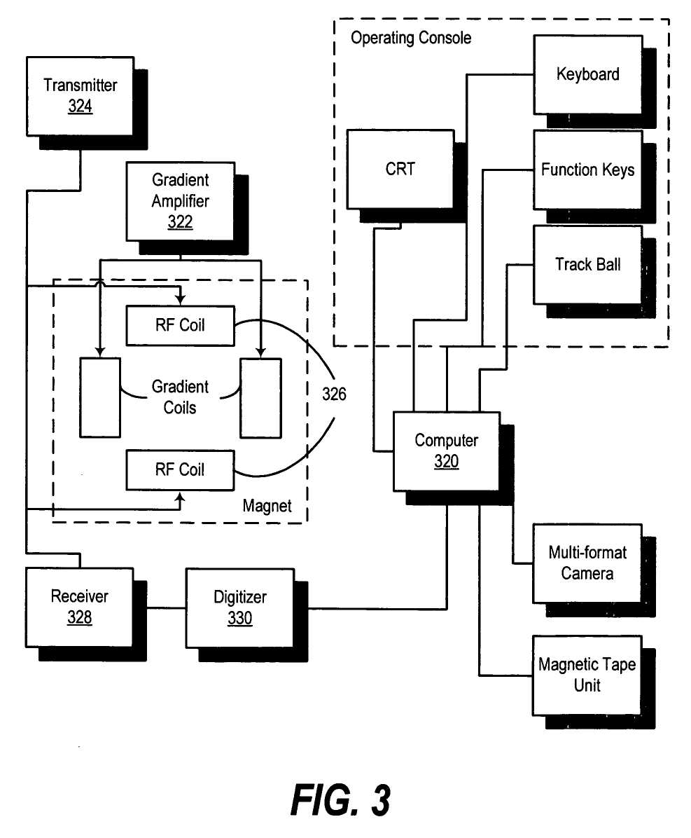

FIG. 3 is a functional block diagram of a conventional imaging apparatus. A computer 320 is programmed to control the operation of the NMR apparatus and process free induction decay (FID) signals detected therefrom. The gradient field is energized by a gradient amplifier 322, and the RF coils 326 for impressing an RF magnetic moment at the Larmor frequency are controlled by the transmitter 324. After the selected nuclei have been flipped, the RF coil 326 is employed to detect the FID signal which is passed to the receiver 328 and thence through digitizer 330 for processing by computer 320.

In multispectral MRI imaging, multiple MRI images are obtained using varying sequences of RF pulses, and the images so obtained are analyzed (by performing exponential curve-fitting) to determine the intrinsic NMR-related properties of the sample (T₁, T₂, and P_{d}) corresponding to each pixel location in the series of images (P_{d} is proton density). One commonly used pulse sequence is the spin-echo pulse sequence, in which a 90° pulse is followed by a 180° pulse, which causes the sample to produce an echo signal. The signal equation for a repeated spin echo sequence as a function of the repetition time, T_{R}, and the echo time, T_{E}, (defined as the time between the 90° pulse and the maximum amplitude in the echo) is
S=k P_{d}(1−e^{-T}^{_{R}}^{/T}^{₁})e^{-T}^{_{E}}^{/T}^{₂},
where k is Boltzmann's constant (1.3805×10⁻²³ J/K). In a typical spin-echo imaging application, exponential curve-fitting is performed to calculate the time constants T₁ and T₂, from which the proton density P_{d} can be calculated from the above equation. The result of multispectral MRI imaging is a set of three images, the grey values in each image representing a different one of the three intrinsic properties of the sample being imaged (T₁, T₂, and P_{d}). Taken together, the results may be interpreted as a field of vector-valued pixels (or voxels, in the case of three-dimensional imaging), where the components of the vectors are values of T₁, T₂, and P_{d}.

In the early 1970s Dr. Raymond Damadian demonstrated that different types of tissues have different T₁,T₂, and P_{d} values and that multispectral MRI could be used to detect cancerous cells by identifying characteristic values of T₁,T₂, and P_{d}. See, e.g., U.S. Pat. No. 3,789,832 (DAMADIAN) 1974-2-5.

Training Data and Classifier Generation

A preferred embodiment of the present invention is directed to generating a set of training data that can be used to train a classifier to utilize multispectral MRI data to distinguish between normal and cancerous tissues in an organ such as the liver. Specifically, the classifier so obtained can be utilized to classify a given pixel location in a set of multispectral MRI images as being potentially cancerous or not and can thus allow small amounts of potentially cancerous tissue to be readily identified.

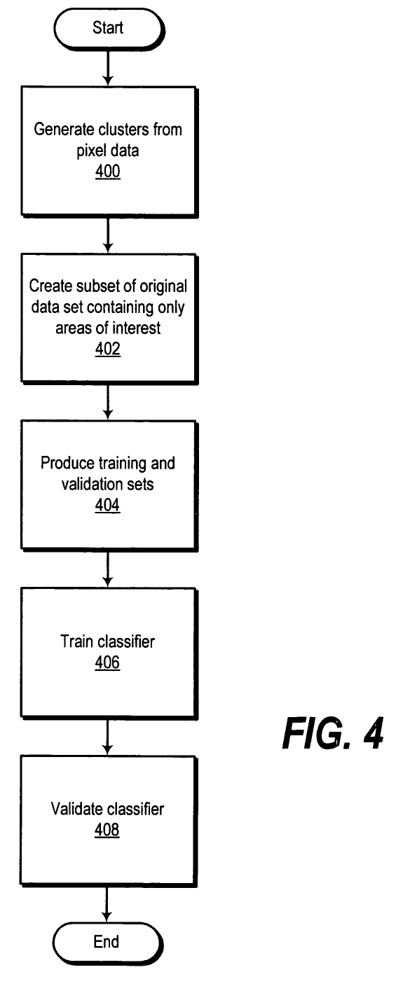

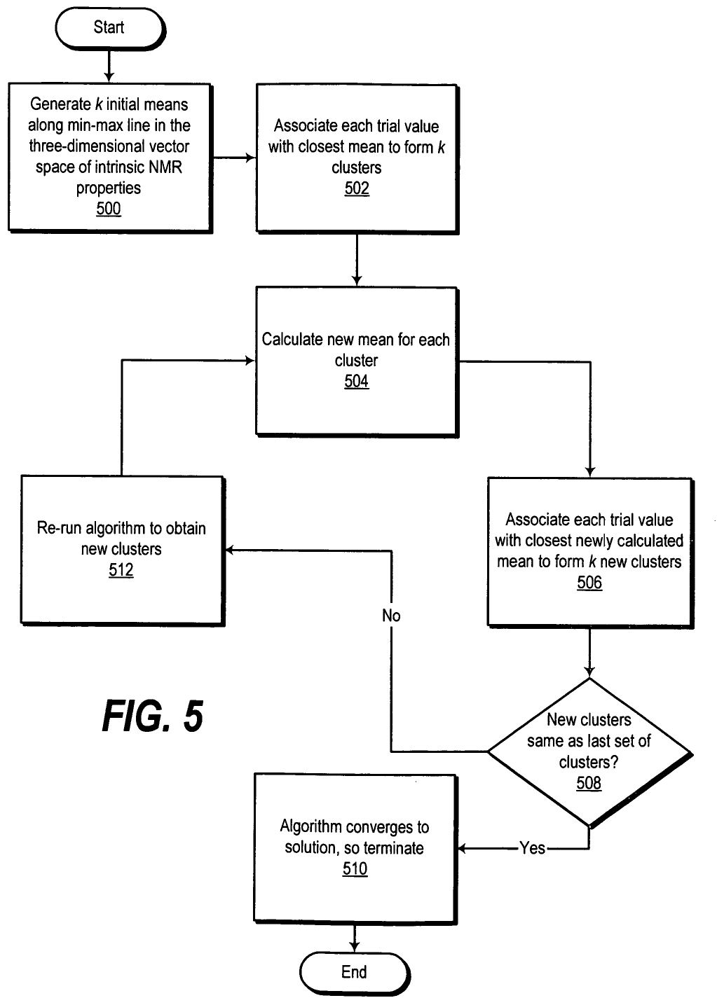

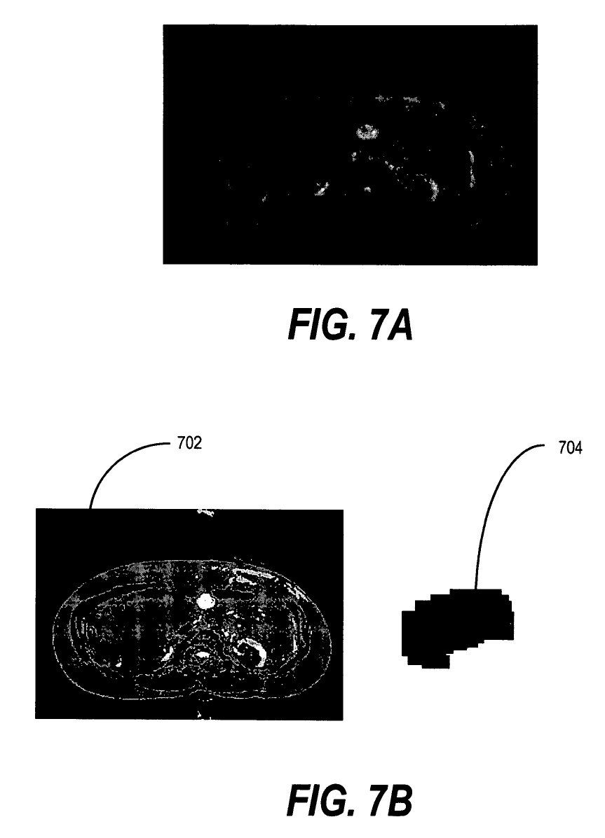

FIG. 4 is a flowchart representation of a process of generating a set of multispectral MRI training data and using that training data to develop a tissue classifier in accordance with a preferred embodiment of the present invention. First, the vector-valued pixel values are organized into a fixed number of clusters of similarly-valued pixels (block 400); this process is described in further detail in FIG. 5. Organizing the data in this way allows the contrast between different types of tissues to be displayed graphically. For example, the ordinary grayscale MRI image shown in FIG. 7A can be redisplayed using different colors in a manner similar to image 702 in FIG. 7B, where each color represents a different cluster to which a particular pixel belongs.

According to the preferred embodiment a contrast-enhanced image of this type is then displayed to a human domain expert, who selects only those clusters corresponding to tissues of interest to be retained in the training data (block 402), as shown in image 704 of FIG. 7B. The domain expert then annotates the selected image data to show which pixels correspond to tissue of one type (e.g., cancerous tissue) and which pixels correspond to (an)other type(s) (e.g., non-cancerous tissue), to produce training and validation data sets (block 404) suitable for supervised learning (i.e., some of the annotated data will become training data and some will become validation data). The training data is then used to train a classifier (block 406). The validation data is then used to validate the accuracy of the derived classifier (block 408).

Many different well-known varieties of classifiers suitable for supervised learning exist in the art, and any of these may be trained and validated using training and validation data derived according to a preferred embodiment of the present invention, without limitation, and without departing from the scope and spirit of the present invention. Some examples of suitable classifiers include, but are by no means limited to, Bayesian classifiers, nearest-neighbor and other case-based classifiers, Parzen window classifiers, linear discriminant classifiers (such as Fisher's linear discriminant technique), and (where adapted to reasoning about real-valued numerical values) inductive logic programs, induced decision trees (such as are obtained by Quinlan's ID3 algorithm, for example), and the like. In one possible embodiment of the present invention, a plurality of classifiers may be trained using the obtained training data and the most accurate one ultimately selected by evaluating the classifiers using validation data.

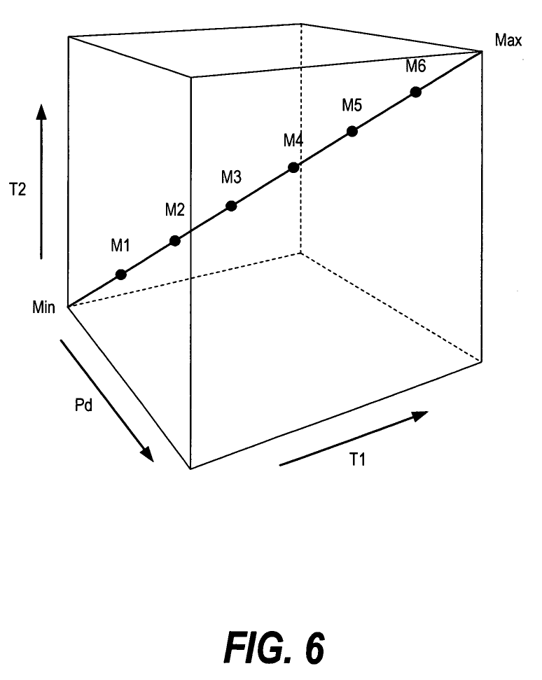

FIG. 5 is a flowchart representation of a process of organizing the multispectral MRI data into clusters in accordance with a preferred embodiment of the present invention. The procedure described in FIG. 5 is a deterministic variant of the algorithm known as “k—means clustering,” which is specially tailored to multispectral MRI data analysis. First a set of k “initial means” (k being the number of clusters to be created) is generated in the three-dimensional vector space formed by the Cartesian product of the three intrinsic NMR properties T₁,T₂, and P_{d} (block 500). Unlike the conventional k-means clustering algorithm, which selects the initial means randomly, these k initial means are instead selected deterministically. Specifically, the k initial means are selected as equidistantly spaced points along a straight line extending from a minimum data point among the vector-valued MRI data to a maximum value among the vector-valued MRI data, as shown in FIG. 6 (where points M1-M6 represent 6 initial means). This deterministic method of selecting the k initial means for performing the clustering is particularly advantageous in that it ensures solution uniqueness and convergence and also allows for variations in image quality, due to its non-parametric nature.

After the initial means have been computed, each trial value (i.e., each vector value in the MRI data) is compared to each mean to determine the mean to which that trial value is closest (by Euclidean distance measure, for example) (block 502). By associating each trial value with its closest mean, the trial values are organized into k clusters. Next, the actual mean (or “centroid”) of each cluster is calculated to form k new means (block 504). The trial values are then associated with their corresponding closest means in the new set of means (block 506).

At this point, a determination is made as to whether the clusters obtained from the new means each have the same members as the corresponding clusters obtained from the previous set of means (block 508). If so (block 508: yes), then a solution has been found, so the process terminates (block 510). If not, however, (block 508: no), the process cycles to obtain a new set of means and corresponding clusters (block 512).

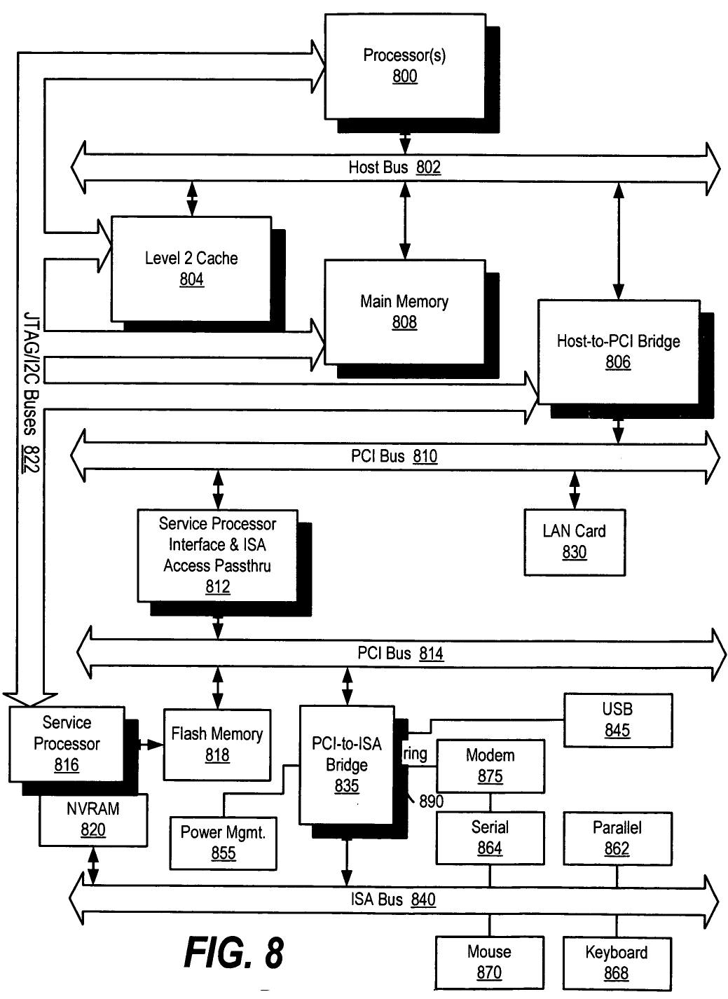

FIG. 8 illustrates information handling system 801 which is a simplified example of a computer system capable of performing the computing operations of the host computer described herein with respect to a preferred embodiment of the present invention. Computer system 801 includes processor 800 which is coupled to host bus 802. A level two (L2) cache memory 804 is also coupled to host bus 802. Host-to-PCI bridge 806 is coupled to main memory 808, includes cache memory and main memory control functions, and provides bus control to handle transfers among PCI bus 810, processor 800, L2 cache 804, main memory 808, and host bus 802. Main memory 808 is coupled to Host-to-PCI bridge 806 as well as host bus 802. Devices used solely by host processor(s) 800, such as LAN card 830, are coupled to PCI bus 810. Service Processor Interface and ISA Access Pass-through 812 provide an interface between PCI bus 810 and PCI bus 814. In this manner, PCI bus 814 is insulated from PCI bus 810. Devices, such as flash memory 818, are coupled to PCI bus 814. In one implementation, flash memory 818 includes BIOS code that incorporates the necessary processor executable code for a variety of low-level system functions and system boot functions.

PCI bus 814 provides an interface for a variety of devices that are shared by host processor(s) 800 and Service Processor 816 including, for example, flash memory 818. PCI-to-ISA bridge 835 provides bus control to handle transfers between PCI bus 814 and ISA bus 840, universal serial bus (USB) functionality 845, power management functionality 855, and can include other functional elements not shown, such as a real-time clock (RTC), DMA control, interrupt support, and system management bus support. Nonvolatile RAM 820 is attached to ISA Bus 840. Service Processor 816 includes JTAG and I2C buses 822 for communication with processor(s) 800 during initialization steps. JTAG/I2C buses 822 are also coupled to L2 cache 804, Host-to-PCI bridge 806, and main memory 808 providing a communications path between the processor, the Service Processor, the L2 cache, the Host-to-PCI bridge, and the main memory. Service Processor 816 also has access to system power resources for powering down information handling device 801.

Peripheral devices and input/output (I/O) devices can be attached to various interfaces (e.g., parallel interface 862, serial interface 864, keyboard interface 868, and mouse interface 870 coupled to ISA bus 840. Alternatively, many I/O devices can be accommodated by a super I/O controller (not shown) attached to ISA bus 840.

In order to attach computer system 801 to another computer system to copy files over a network, LAN card 830 is coupled to PCI bus 810. Similarly, to connect computer system 801 to an ISP to connect to the Internet using a telephone line connection, modem 875 is connected to serial port 864 and PCI-to-ISA Bridge 835.

While the computer system described in FIG. 8 is capable of executing the processes described herein, this computer system is simply one example of a computer system. Those skilled in the art will appreciate that many other computer system designs are capable of performing the processes described herein.

One of the preferred implementations of the invention is a client application, namely, a set of instructions (program code) or other functional descriptive material in a code module that may, for example, be resident in the random access memory of the computer. Until required by the computer, the set of instructions may be stored in another computer memory, for example, in a hard disk drive, or in a removable memory such as an optical disk (for eventual use in a CD ROM) or floppy disk (for eventual use in a floppy disk drive), or downloaded via the Internet or other computer network. Thus, the present invention may be implemented as a computer program product for use in a computer. In addition, although the various methods described are conveniently implemented in a general purpose computer selectively activated or reconfigured by software, one of ordinary skill in the art would also recognize that such methods may be carried out in hardware, in firmware, or in more specialized apparatus constructed to perform the required method steps. Functional descriptive material is information that imparts functionality to a machine. Functional descriptive material includes, but is not limited to, computer programs, instructions, rules, facts, definitions of computable functions, objects, and data structures.

While particular embodiments of the present invention have been shown and described, it will be obvious to those skilled in the art that, based upon the teachings herein, changes and modifications may be made without departing from this invention and its broader aspects. Therefore, the appended claims are to encompass within their scope all such changes and modifications as are within the true spirit and scope of this invention. Furthermore, it is to be understood that the invention is solely defined by the appended claims. It will be understood by those with skill in the art that if a specific number of an introduced claim element is intended, such intent will be explicitly recited in the claim, and in the absence of such recitation no such limitation is present. For non-limiting example, as an aid to understanding, the following appended claims contain usage of the introductory phrases “at least one” and “one or more” to introduce claim elements. However, the use of such phrases should not be construed to imply that the introduction of a claim element by the indefinite articles “a” or “an” limits any particular claim containing such introduced claim element to inventions containing only one such element, even when the same claim includes the introductory phrases “one or more” or “at least one” and indefinite articles such as “a” or “an;” the same holds true for the use in the claims of definite articles.

What is claimed is:

1. A computer-implemented method comprising:
organizing a set of image data into a pre-determined number of clusters;
selecting a pertinent subset of the pre-determined number of clusters; and
training a classifier using the pertinent subset of the pre-determined number of clusters as training data.

2. The method of claim 1, wherein the classifier is trained to distinguish among different types of tissue in an organism.

3. The method of claim 2, wherein the different types of tissue include cancerous tissue and non-cancerous tissue.

4. The method of claim 1, wherein the image data is vector-valued.

5. The method of claim 2, wherein each vector-valued data point in the image data includes a spin-lattice relaxation time constant, a free induction decay time constant, or a proton density.

6. The method of claim 1, further comprising:
generating validation data from the pertinent subset; and
validating the trained classifier using the validation data.

7. The method of claim 1, wherein organizing the set of image data into the pre-determined number of clusters includes:
identifying maximum and minimum data points in the set of image data;
defining a line from the maximum and minimum data points;
designating a plurality of points along the line as initial cluster means; and
applying a clustering algorithm to the set of image data using the initial cluster means so as to define the pre-determined number of clusters.

8. The method of claim 7, wherein applying the clustering algorithm includes:
associating each data point in the set of image data with a corresponding closest cluster mean in the initial cluster means to form a first plurality of intermediate clusters;
calculating a mean value for each of the first plurality of intermediate clusters to form a set of intermediate cluster means;
associating each data point in the set of image data with a corresponding closest cluster mean from the set of intermediate cluster means to form a second plurality of intermediate clusters;
comparing the first plurality of intermediate clusters with the second plurality of intermediate clusters;
computing a new set of clusters from the second plurality of intermediate clusters, if the first plurality of intermediate clusters differs from the second plurality of intermediate clusters; and
designating the second plurality of intermediate clusters as the pre-determined number of clusters, if the first plurality of intermediate clusters matches the second plurality of intermediate clusters.

9. The method of claim 1, wherein the pertinent subset is selected by obtaining user input.

10. The method of claim 1, further comprising:
identifying maximum and minimum data points in the set of magnetic resonance image data;
defining a line from the maximum and minimum data points;
designating the pre-determined number of points along the line as initial cluster means; and
applying a clustering algorithm to the set of image data using the initial cluster means so as to define the pre-determined number of clusters; and
obtaining user input to select the pertinent subset of the clusters used in the training.

11. A computer program product comprising functional descriptive material that, when executed by a computer, causes the computer to perform actions that include:
organizing a set of image data into a pre-determined number of clusters;
selecting a pertinent subset of the pre-determined number of clusters; and
training a classifier using the pertinent subset of the pre-determined number of clusters as training data.

12. The computer program product of claim 11, wherein the image data is multispectral magnetic resonance image data.

13. The computer program product of claim 11, wherein organizing the set of image data into the pre-determined number of clusters includes:
identifying maximum and minimum data points in the set of image data;
defining a line from the maximum and minimum data points;
designating a plurality of points along the line as initial cluster means; and
applying a clustering algorithm to the set of image data using the initial cluster means so as to define the pre-determined number of clusters.

14. The computer program product of claim 11, comprising additional functional descriptive material that, when executed by a computer, causes the computer to perform additional actions of:
generating validation data from the pertinent subset; and
validating the trained classifier using the validation data.

15. The computer program product of claim 14, wherein applying the clustering algorithm includes:
associating each data point in the set of image data with a corresponding closest cluster mean in the initial cluster means to form a first plurality of intermediate clusters;
calculating a mean value for each of the first plurality of intermediate clusters to form a set of intermediate cluster means;
associating each data point in the set of image data with a corresponding closest cluster mean from the set of intermediate cluster means to form a second plurality of intermediate clusters;
comparing the first plurality of intermediate clusters with the second plurality of intermediate clusters;
computing a new set of clusters from the second plurality of intermediate clusters, if the first plurality of intermediate clusters differs from the second plurality of intermediate clusters; and
designating the second plurality of intermediate clusters as the pre-determined number of clusters, if the first plurality of intermediate clusters matches the second plurality of intermediate clusters.

16. The computer program product of claim 11, wherein the pertinent subset is selected by obtaining user input.

17. A data processing system comprising:
at least one processor;
at least one data store accessible to the at least one processor; and
a set of instructions in the at least one data store, wherein the at least one processor executes the set of instructions to perform actions that include:
organizing a set of image data into a pre-determined number of clusters;
obtaining, from user input, a selection of a pertinent subset of the pre-determined number of clusters; and
training a classifier using the pertinent subset of the pre-determined number of clusters as training data.

18. The data processing system of claim 17, wherein the image data includes multispectral magnetic resonance image data.

19. The data processing system of claim 17, wherein organizing the set of image data into the pre-determined number of clusters includes:
identifying maximum and minimum data points in the set of image data;
defining a line from the maximum and minimum data points;
designating a plurality of points along the line as initial cluster means; and
applying a clustering algorithm to the set of image data using the initial cluster means so as to define the pre-determined number of clusters.

20. The data processing system of claim 19, wherein applying the clustering algorithm includes:
associating each data point in the set of image data with a corresponding closest cluster mean in the initial cluster means to form a first plurality of intermediate clusters;
calculating a mean value for each of the first plurality of intermediate clusters to form a set of intermediate cluster means;
associating each data point in the set of image data with a corresponding closest cluster mean from the set of intermediate cluster means to form a second plurality of intermediate clusters;
comparing the first plurality of intermediate clusters with the second plurality of intermediate clusters;
computing a new set of clusters from the second plurality of intermediate clusters, if the first plurality of intermediate clusters differs from the second plurality of intermediate clusters; and
designating the second plurality of intermediate clusters as the pre-determined number of clusters, if the first plurality of intermediate clusters matches the second plurality of intermediate clusters.
